(19) United States
(12) Patent Application Publication
(10) Pub. No.: US 2002/0031691 A1
(43) Pub. Date: Mar. 14, 2002

(54) Fuel cell system

(76) Inventor: Isabel Haas, Kirchheim (DE)

Correspondence Address: CROWELL & MORING, L.L.P, P.O.Box 14300, Washington, DC, 20044-4300, US

(21) Appl. No.: 09/931,173

(22) Filed: Aug. 17, 2001

(30) Foreign Application Priority Data
Aug. 17, 2000 (DE) 100 40 124.4

(51) Int. Cl. H01M 8/04

(52) U.S. Cl. 429/22; 429/34; 429/13

(57) ABSTRACT

A fuel cell system has at least one fuel cell unit, an anode-side medium-supply element for supplying an operating medium, and anode-side medium-discharge element for discharging an outgoing anode stream. A cathode-side medium-supply element supplies an oxidizing agent and a cathode-side medium-discharge element discharges an outgoing cathode stream. A dewatering device is arranged in the fuel cell system, for removing water from a flow of medium. Upstream of or at the entry or at the entry region of the dewatering device, a unit is provided for adjusting the rate at which water is separated out of the flow of medium.

### BACKGROUND AND SUMMARY OF THE INVENTION

This application claims the priority of German patent document 100 40 124.4, filed in Germany, Aug. 17, 2000, the disclosure of which is expressly incorporated by reference herein.

The invention relates to a fuel cell system having a dewatering device in an outgoing gas flow thereof, and to a method for removing water in a flow of gaseous medium of a fuel cell unit.

German Patent Document DE 195 31 852 C1 discloses a fuel cell system in which a water separator is provided for the purpose of removing product water. The water separator has a control device in the form of a valve, which automatically empties the water separator.

One object of the present invention is to provide a fuel cell system in which the water separation is improved.

This and other objects and advantages are achieved in the fuel cell system according to the invention, in which upstream of (or in) the dewatering device means are provided for adjusting the degree of separation of water out of the outgoing flow of medium. This arrangement has the advantage that the flow of medium can be carried with an optimum flow velocity and/or an optimum flow path in the dewatering device in any load range. Consequently the dewatering device has a high efficiency.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a part of a preferred fuel cell system according to the invention.

### DETAILED DESCRIPTION OF THE DRAWINGS

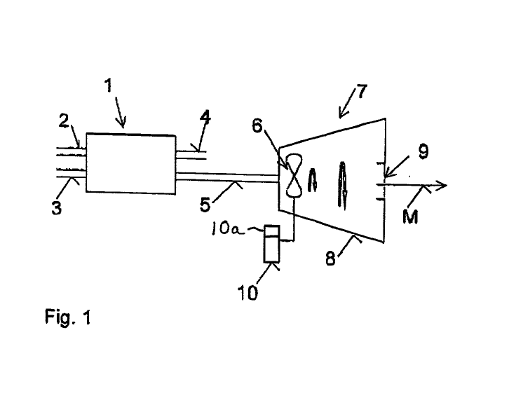

As depicted in FIG. 1, a fuel cell system according to the invention has at least one fuel cell unit 1, with anode-side medium-supply means 2 for supplying an operating medium (e.g., hydrogen gas) and anode-side medium-discharge means 4 for discharging an outgoing anode stream. A cathode-side medium-supply means 3 supplies an oxidizing agent (e.g., oxygen or air) and a cathode-side medium-discharge means 5 discharges an outgoing cathode stream (for example water and oxygen). A dewatering device 7 for removing water from a flow of medium M is arranged downstream of the fuel cell unit 1. The dewatering device 7 is preferably a water separator.

The dewatering device 7 according to the invention may advantageously be used at that location in the system where water is to be removed from a flow of medium. It may be provided upstream or downstream of the fuel cell unit 1. Upstream of, at the entry, or in the entry region inside the dewatering device 7, a fan 6 and drive means 10 are provided for adjusting the degree of separation of the water from the flow of medium M.

Usually, a water separator is designed so that, at a defined operating point, a separation rate which is optimum for the water separator can be achieved. This may, for example, follow a defined flow velocity of the medium which is to be dewatered. The efficiency of the dewatering device (i.e., the separation rate) is usually a function of the velocity of the medium.

However, the velocity of the medium itself is dependent on the load of the fuel cell. At part-load, it is low, while at full load, it is high. As a result, the separation rate of the dewatering device is dependent on the load state of the fuel cell. On the other hand, in the fuel cell arrangement, according to the invention, the separation rate can be adjusted independently of load; and the quantity of water which is separated out can be determined by the rotational speed of a fan wheel.

According to the invention, the drive means 10 is controlled by a control unit 10a to drive the fan 6 in a load-dependent manner. (At a low load of the fuel cell system, the throughput of medium is lower than at full load.) The fan is preferably driven in such a way that at any load range of the fuel cell system it is possible to achieve a flow velocity of the flow of medium M at which the water separator has a high efficiency. For this purpose, it is advantageous if the flow velocity can be adjusted constantly, as far as possible to be independent of the load on the fuel cell. In this case, the humid flow of medium M can always be guided into the water separator at the velocity for which the separator is optimized and at which the separator is at its optimum efficiency and achieves its optimum separation rate.

The fan 6 is preferably driven by an electric motor 10 which changes the rotational speed of the fan wheel of the fan 6 as a function of the load on the fuel cell unit. At a high load, at which the incoming flow velocity of the flow of medium M is high, the rotational speed can be lower than at a low load, so that the flow of medium M is substantially accelerated under part-load.

It is expedient to set the water-containing flow of medium M in circulating motion in the interior of the dewatering device 7. In this case, the water which is entrained in the humid flow of medium M can be deposited on the housing 8 of the dewatering device 7 and can be passed into a collection vessel (not shown). In this manner, the effective path of the medium inside the dewatering device 7 is extended; and the condensation surface area is better utilized. At least in regions, the housing 8 may be provided as a cooling surface for condensing water out of the flow of medium M.

It is advantageous if the clear cross section of the housing 8 increases in the direction of flow, as depicted in the figure. However, it is also possible for the housing to be designed in such a way that the clear cross section of the housing 8 decreases or remains constant in the direction of flow.

Expediently, the dewatering device 7 is arranged at one or more of the following locations: in the cathode-side medium-discharge means 5, in the outgoing anode stream, in a flow path of the combined fuel cell exhaust gas (in which the outgoing anode stream and the outgoing cathode stream are brought together) and at other locations in the fuel cell system at which media are to be dewatered. The water which is recovered is advantageously used to humidify cathode air and/or to cool fuel cells. The invention is particularly suitable for fuel cell systems with polymer electrolyte membrane fuel cells.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A fuel cell system comprising:
at least one fuel cell unit, having an anode-side medium-supply input for supplying an operating medium, an anode-side medium-discharge output for discharging an outgoing anode stream, a cathode-side medium-supply input for supplying an oxidizing agent, and a cathode-side medium-discharge output for discharging an outgoing cathode stream;
a dewatering device for removing water from a flow of medium; and
means arranged in an inflow portion of the dewatering device for adjusting a rate at which water is separated out of the flow of medium.

2. The fuel cell system according to claim 1, wherein the means for adjusting the separation rate comprise a fan and drive unit for driving the fan, so that the water-containing flow of medium can be set in circulating motion inside the dewatering device.

3. The fuel cell system according to claim 2, wherein the drive unit drives the fan in a load-dependent manner.

4. The fuel cell system according to claim 1, wherein the dewatering device has a housing which, at least in regions, is provided as a cooling surface for the purpose of condensing water out of the flow of medium.

5. The fuel cell system according to claim 1, wherein a clear cross section of the housing increases in the direction of flow.

6. The fuel cell system according to claim 1, wherein the dewatering device is arranged in an anode-side outgoing stream of medium of said at least one fuel cell unit.

7. The fuel cell system according to claim 1, wherein the dewatering device is arranged in a cathode-side outgoing stream of medium of said at least one fuel cell unit.

8. A dewatering device for removing water from a flow of gaseous medium of a fuel cell system, said dewatering device comprising:
a housing;
an inlet for receiving said flow of gaseous medium into the housing;
an outlet for discharging said flow of gaseous medium from the housing;
a fan arranged in an inflow region of said dewatering device, for adjusting a rate of flow of said gaseous medium in said dewatering device;
a motor for driving the fan; and
a control unit for controlling operation of the motor for driving the fan in a load dependent manner.

9. The dewatering device according to claim 8, wherein said controlunit drives said fan in a manner which maintains said flow of gaseous medium at a rate at which water separation by said dewatering device is optimized.

10. The fuel cell system according to claim 9, wherein a clear cross section of the housing increases in the direction of flow.

11. The fuel cell system according to claim 9, wherein the dewatering device is arranged in an anode-side outgoing stream of medium of said at least one fuel cell unit.

12. The fuel cell system according to claim 9, wherein the dewatering device is arranged in a cathode-side outgoing stream of medium of said at least one fuel cell.

13. A method for removing water from a flow of gaseous medium of a fuel cell having cathode and anode inputs and cathode and anode outputs, said method comprising:
providing a dewatering device connected to receive said flow of gaseous medium;
adjusting a rate of flow of gaseous medium in the inflow region of the dewatering device, in a manner dependent on an operating state of said fuel cell.

14. A method for removing water according to claim 13, wherein said rate of flow is adjusted in a manner which maintains said flow of gaseous medium at a level at which water separation by said dewatering device is optimized.
